(19) United States
(12) Patent Application Publication
(10) Pub. No.: US 2001/0054041 A1
(43) Pub. Date: Dec. 20, 2001

(54) System and method for registering or searching in multiple relationship-searching hosts

(76) Inventor: Lan Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/748,276

(22) Filed: Dec. 27, 2000

Related U.S. Application Data
(60) Provisional application No. 60/173,492, filed on Dec. 29, 1999.

(51) Int. Cl. G06F 17/30

(52) U.S. Cl. 707/5; 707/1; 707/10

(57) ABSTRACT

A method for searching in multiple relationship-searching hosts. The method can be installed in a computer, wherein the computer comprises a user interface (UI) to access search conditions. Firstly the method begins with inputting the search conditions on the UI. Next, the search conditions are transmitted to the hosts with each of the hosts' data format retrieved from a server data format database in the computer. Then the hosts retrieve search results according to the search conditions and transmit the search results to the computer. Next, the search results are stored in a found profile database of the computer. The method makes a user be capable to register and search matched users in the multiple relationship-searching hosts, instead of repeatedly behavior of search in different hosts.

### BACKGROUND OF THE INVENTION

This application incorporates by reference Provisional application Ser. No. 60/173,492, Filed on Dec. 29, 1999.

1. Field Of The Invention

The invention relates in general to register or search in a relationship-searching host, and more particularly to register or search in multiple relationship-searching hosts.

2. Description Of The Related Art

In the past, if people want to communicate with each other, they usually talk face to face or contact by telephones or letters. In modern times computers and network make more convenient for human to communicate. People can directly “talk” (by typing) through some WWW chat sites of Internet or other on-line interactive chat software, such as IRC (Internet Relay Chat), and ICQ (a product of ICQ Inc.) and so on. Besides, several websites or hosts, such as marriage, friendship, partnership, romance, and relation search websites, even provide users to become their members after inputting their own personal information and registering. And these websites are called relationship-searching websites or hosts. These relationship-searching hosts let users to search suitable members by setting their searching conditions.

In general, a relationship-searching website includes a web server and a personal profile database. The web server provides registration and search service for users. And the personal profile database is for storing user profiles. A user profile is for recording personal data of a user. In a computer, a user can use a browser to connect to the web server. When registering to the web server, the web server requests the user to input a user profile. The user profile includes several data columns of personal data of the user. These data columns may include an account or a handle (identification on the website), title, name, instruction, age, country, state, city, desired relationship, gender, interest, religion, education, photo, and so on. After finishing the registration, the user profile is stored in a personal profile database of the website and the user becomes a member of the website. The user can use functions or service provided in the web server, such as searching users who match the conditions. First the user inputs some searching conditions for users who match the conditions, and then the web server searches in the personal profile database. Finally, search results are sent to the browser to display for the user or sent to the user by an email.

Another form of relationship-searching host is a bare personal profile database that can be accessed via network. The database operates without a web server and serves with different interface than hypertext markup language (HTML). But it has similar properties with the said website.

Although these mentioned relationship-searching websites and personal profile database provide many convenient functions for users, they still have some disadvantages described as following.

(1) Narrow range of persons for searching

A user can just search matched users in a website that the user has registered in. However, members of other websites which the user has not registered in can not be searched by the user.

(2) Lack of effective and efficient contact way

Usually these relationship-searching websites just provide a user to contact to matched members by email. And the user usually waits for no response. These websites lack effective and efficient contact way, such as on-line interactive way, talking by typing, talking with video image, and so on. It is difficult and not convenient for the user to proceed further contact.

(3) Repeated similar behavior of registration and search between different websites

When registering or searching matched users in multiple relationship-searching websites, a user has to repeatedly input similar data columns of personal data or searching conditions.

(4) Difficult to be familiar with several different user interface

Since user interfaces, action process and operating steps of each website are different, a user has to be familiar with different design of these websites.

(5) Incapability of send emails to different people simultaneously

When sending an instruction to matched users, a user can not send emails simultaneously in the mechanism of current websites. The user has to send an email once.

(6) Inconvenient to make appointments to matched users

These websites do not provide on-line or physical appointment requesting and answering system to a user for making an appointment.

### SUMMARY OF THE INVENTION

It is therefore an object of the invention to provide a system and a method for registering or searching in multiple relationship-searching websites or hosts. The system and the method provide a user with being capable to register or search matched users in multiple relationship-searching websites or hosts once instead of repeatedly behavior of registration or search in different websites. Besides, the system even provides users with on-line contact way to further proceed further contact with a matched user.

The invention achieves the above-identified objects by providing a system for searching in multiple relationship-searching hosts, wherein the relationship-searching hosts allow users to search for other users via a communication link. The system comprises a user interface (UI), server data format database, profile poster, user profile database, search poster, a search result analyzer, and a found profile database. The UI is for a user to control the system and the server data format database is for storing data format of search and registration of the relationship-searching hosts. The search poster is for transmitting search conditions, which are inputted via the UI and are defined by the user, to the relationship-searching hosts with each of the transmitting search conditions' data format retrieved from the server data format database. The search result analyzer is for receiving and analyzing search results from the relationship-searching hosts according to the search conditions with each of data format retrieved from the server data format database. And the found profile database is for storing the search results. Wherein, after the user inputs the search conditions via the UI, the search poster transmits the search conditions to the relationship-searching hosts. The hosts receive the search conditions to retrieve the search results and then transmit the search results to the search result analyzer. And the search results are stored in the found profile database.

The system can be installed in a client terminal to provide the user to connect the relationship-searching hosts via the communication link. The system further comprises a direct channel and an on-line search unit. A direct channel is for being installed in a relationship-searching host to provide a faster connection to access a personal profile database of the relationship-searching host. The on-line search unit is for being installed in the client terminal for the user to input on-line search conditions, search an on-line matched user in the relationship-searching host and provide on-line contact to the on-line matched user. And the on-line search unit comprises a TSR (terminate-and-stay-resident) and an on-line messenger. The TSR is a process residing in a operation system (OS) of the client terminal and is for keeping connecting to the personal profile database of the relationship-searching host via the direct channel. The on-line messenger is for building on-line communication to the on-line matched user. Wherein, the user inputs the on-line search conditions via the first UI and then the TSR transmits the on-line search conditions to the direct channel. Next, the direct channel retrieves an on-line search result and transmits the on-line search result to the TSR and the on-line messenger is triggered to build the on-line communication to the on-line matched user of the on-line search result.

Additionally, the system can also be installed in a server and the user uses a client terminal to connect to the server via the communication link.

The invention achieves the above-identified objects by further providing a system for registering in multiple relationship-searching hosts, wherein the relationship-searching hosts allow users to register via a communication link. The system comprises a user interface (UI), server data format database, profile poster, and user profile database. The UI is for a user to control the system and the server data format database is for storing data format of registration of the relationship-searching hosts. A profile poster is for transmitting a new or modified user profile inputted via the UI to the relationship-searching hosts with each of the transmitting new or modified profile's data format retrieved from the server data format database. The user profile database is for storing the new or modified profile. Wherein, after the user inputs the user profile via the UI, the profile poster updates the user profile database and transmits the user profile to the relationship-searching hosts; and the relationship-searching hosts then receive the user profile.

The invention achieves the above-identified objects by further providing a method for registering in multiple relationship-searching hosts by a computer to access a user profile. Firstly the method begins with inputting or modifying the user profile in the computer. The user profile is then stored in a user profile database in the computer and posted to the hosts with each of the hosts' data format retrieved from a server data format database in the computer.

Besides, if the user has registered on any relationship-searching website or host that is able to be accessed by the software which uses the method, the software may access the user profile data registered in the website. Then the user may add new items or change items in the profile. The user profile can be stored in the user profile database and then be posted to other relationship-searching hosts.

The invention achieves the above-identified objects by further providing a method for searching in multiple relationship-searching hosts via a computer, wherein the computer comprises a user interface (UI) to access search conditions. Firstly the method begins with inputting the search conditions on the UI . Next, the search conditions are transmitted to the relationship-searching hosts with each of the hosts' data format retrieved from a server data format database in the computer. Then the hosts retrieve search results according to the search conditions and transmit the search results to the computer. Next, the search results are stored in a found profile database of the computer.

### BRIEF DESCRIPTION OF THE DRAWINGS

Other objects, features, and advantages of the invention will become apparent from the following detailed description of the preferred but non-limiting embodiments. The description is made with reference to the accompanying drawings, in which:

FIG. 1 is a network computer system block diagram of a system for registering and searching in multiple relationship-searching websites according to the preferred embodiment of the invention.

FIG 2. is a system block diagram of the search software in the computer of FIG. 1.

FIG. 3 is a flowchart of the method for registering to multiple relationship-searching websites.

FIG. 4 is a flowchart of the method for searching matched members of multiple relationship-searching websites.

FIG. 5 is a flowchart of the method for refining.

FIG. 6 is a block diagram of the on-line search unit in FIG. 2

FIG. 7 is a flowchart of the method for on-line search.

FIG. 8 is a block diagram of the on-line messenger in FIG. 6.

FIG. 9 is a block diagram of the email analyzing unit in FIG. 2.

FIG. 10 is a flowchart of the method for checking emails.

FIG. 11 is a flowchart of the method for arranging an appointment.

FIG. 12 is a network computer system block diagram of the system for registering and searching in multiple relationship-searching websites according to the preferred embodiment of the invention.

FIG. 13 is a system block diagram of the search engine of the server in FIG. 12.

FIG. 14 is a network system block diagram of the first on-line search method.

FIG. 15 is a flowchart of the method for on-line search.

FIG. 16 is a network system block diagram of the second on-line searching method.

FIG. 17 is a block diagram of the email analyzing unit in FIG. 13.

### DESCRIPTION OF THE PREFERRED EMBODIMENT

The system and method of this invention provide a user to be able to register and search matched users in multiple relationship-searching websites. Besides, the user can proceed to further contact to those matched users by on-line communication or emails.

### EXAMPLE ONE

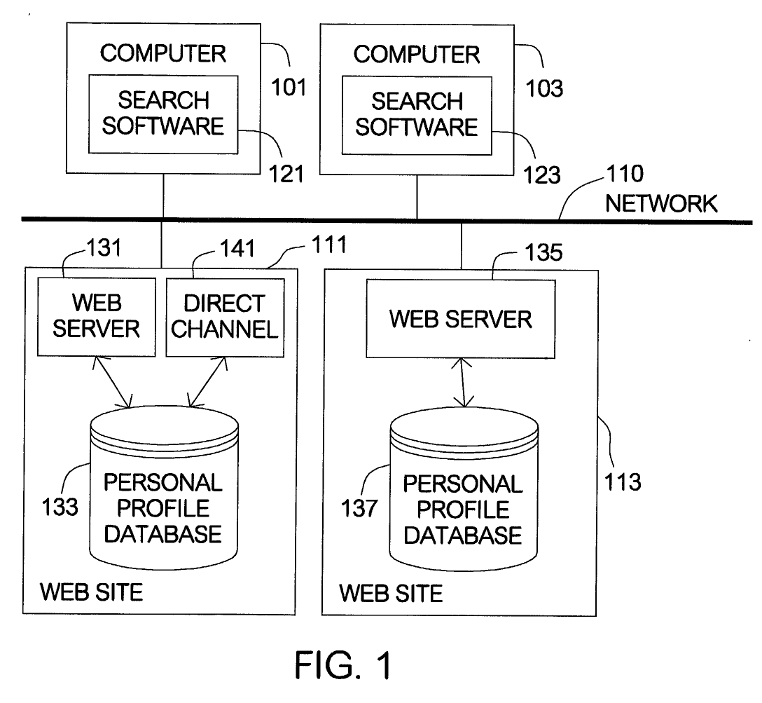

Referring to FIG. 1, it shows the network computer system block diagram of a system for registering and searching in multiple relationship-searching websites according to the preferred embodiment of the invention. In FIG. 1, a website 111 and web site 113 are relationship-searching web sites, such as marriage-searching websites, friendship-searching websites, partnership-searching websites or romance-searching web sites. The website 111 and web site 113 provide service of registration and searching matched users. The web site 113 is acommon relationship-searching website. It includes a web server 135 and a personal profile database 137. The web server 135 is for providing users with service of registration and search. And the personal profile database 137 is for storing user profiles. User profiles are for recording personal data of users and include many data columns, such as an account (identification on a website), title, name, instruction, age, country, state, city, desired relationship, gender, interest, religion, education, photo, and so on.

The relationship-searching website 111 includes not only a web server 131 and personal profile database 133 but also a direct channel 141. Functions of the web server 131 and personal profile database 133 are equivalent to the web server 133 and personal profile database 137. The direct channel 141 is for providing an interface to fast access the personal profile database 133.

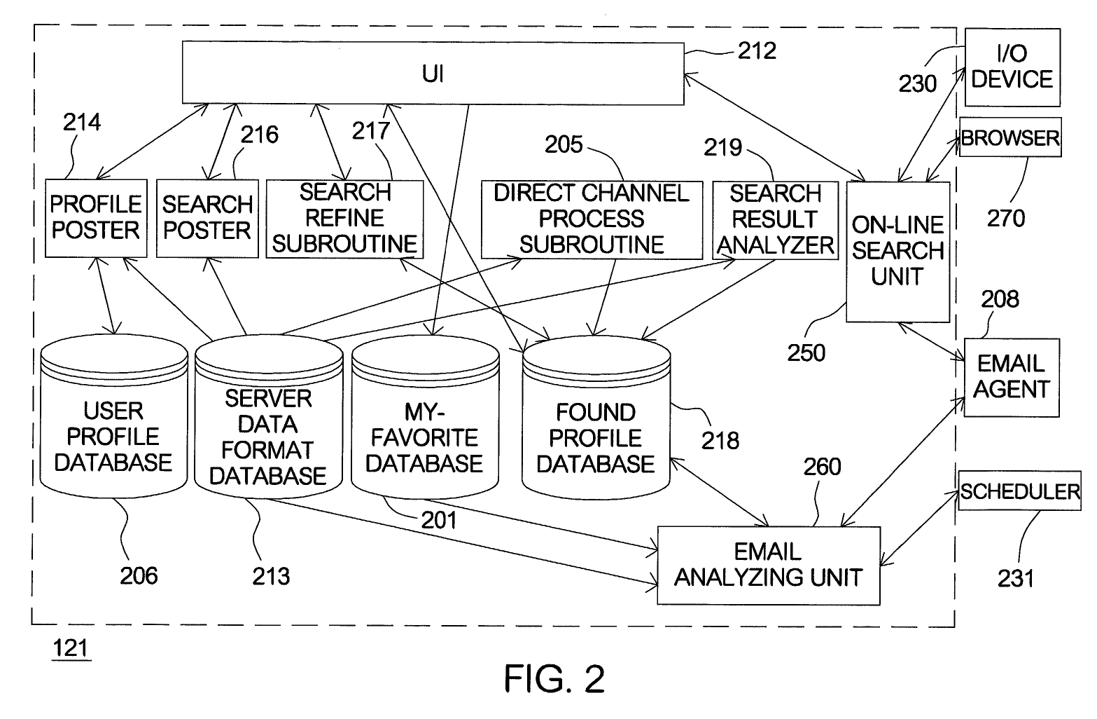

In FIG. 1, a computer 101 and computer 103 connect to the web site 111 and website 113 via a network 110. Furthermore, the system for registering and searching in multiple relationship-searching websites includes a search software 121, which is installed in a computer 101. The search software 121 is for providing a user with registering and searching in several websites. Referring to FIG. 2, it illustrates the system block diagram of the search software 121 in the computer 101 of FIG. 1.

In FIG. 2, a user interface (UI) 212 is for the user to control the system. And the UI 212 can be a graphical user interface. A profile poster 214 is for providing the user with registering or modifying user profiles in website 111 and website 113. A user profile database 206 is for storing user profiles. A search poster 216 provides the user with searching in multiple websites and a search refine subroutine 217 can further refine search results. A direct channel process subroutine 205 and search result analyzer 219 are for receiving search results from website 111 or website 113. And the format of search results can be the hypertext markup language (HTML), extensible markup language(XML), or other languages. A found profiles database 218 is for storing the search results. And the found profile database 218 can be built on memory, disk or any storage device. A my-favorite database 201 is for the user to selectively store the search results. A server data format database 213 is for storing data format of registration and search of multiple relationship-searching websites. And it provides corresponding data format of every relationship-searching website for the profile poster 214, search poster 216, direct channel process subroutine 205 and search result analyzer 219. So, the server data format database 213 has to be regularly updated when a new relationship-searching website produces or another one changes its data format.

In addition, the search software 121 even includes an on-line search unit 250 and an email analyzing unit 260, The on-line search unit 250 is for searching an on-line matched user and provides on-line contact to the on-line matched user via an I/O device 230 or an email agent 208. The email analyzing unit 260 is for checking a new emails received by the email agent 208. Please refer the following description in detail. At first, it is supposed that user A uses the computer 101.

Registration or Modification of User Profile

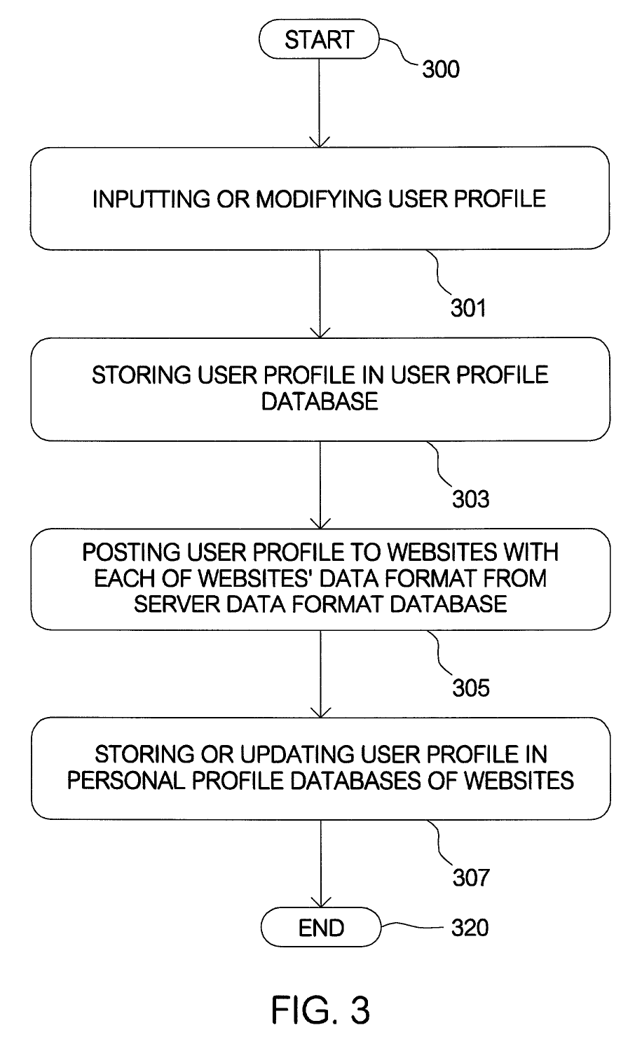

Please refer FIG. 3 in the meanwhile. FIG. 3 illustrates the flowchart of the method for registering to multiple relationship-searching websites. Firstly at the step 301, user A inputs or modifies a user profile on the UI 212. The user profile includes many data columns of personal data, such as an account or a handle (identification on a website), title, name, instruction, age, country, state, city, desired relationship, gender, interest, religion, education, photo, and so on. Next, at the step 303, the profile poster 214 stores or updates the user profile in the user profile database 206 and the next step is the step 305.

At the step 305, the profile poster 214 posts the user profile to website 111 and website 113 with each of websites' data format retrieved from the server data format database 213. At this step, the profile poster 214 can post the user profile to multiple websites once. Wherein, their data format could be the format of HTML or HTTP-posting. And the profile poster 214 can further ask user A which websites the user profile is posted to.

Then the method proceeds to the step 307. At the step 307, the web server 135 of the website 113 and the direct channel 141 of the website 111 receive the user profile and stores or updates the user profile of user A in the personal profile database 133 and personal profile database 137. The direct channel 141 provides faster connection to access the personal profile database 135 because retrieved results are not necessary to be converted to HTML format. The method for registering or modifying a user profile in multiple websites is finished. And user A becomes a member of the website 111 and website 113.

Besides, if the user has registered on any website that is able to be accessed by the software which uses the method, the software may access the user profile data registered in the website. Then the user may add new items or change items in the profile. The user profile can be stored in the user profile database and then be posted to other websites. And the profile poster 214 is also for deleting the user profile from the user profile database 206 and the website 111 and website 113 by the user A.

Searching

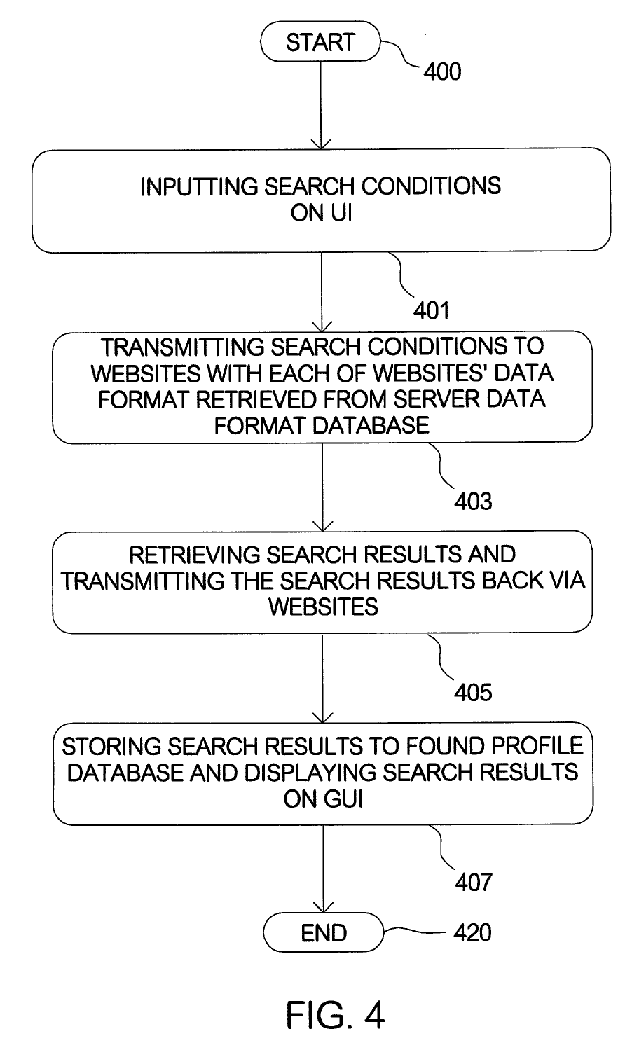

Referring to FIG. 4, it shows the flowchart of the method for searching matched users of multiple relationship-searching websites. The method begins with the step 401. At the step 401, user A inputs search conditions on the UI 212. The search conditions could be range of ages, gender, educational background and so on. Next, at the step 403, the search poster 216 transmits the search conditions to the website 111 and website 113 with each of websites' data format retrieved from the server data format database 213. At this step, the search poster 216 can post the search conditions to multiple websites once. Wherein, their data format could be the format of HTML or HTTP-posting and the search poster 216 can even ask user A which websites the search conditions are posted to. For example, user A chooses the website 111 and website 113 to post the search conditions.

Then the method proceeds to the step 405. At the step 405, the direct channel 141 of the website 111 and web server 135 of the website 113 receive the search conditions and retrieve search results from the personal profile database 133 and personal profile database 137 according the search conditions. So the search results are a collection of user profiles of matched users who are matched the search conditions in the website 111 and website 113. And the search results are transmitted to the computer 101.

Next, at the step 407, the direct channel process subroutine 205 and search result analyzer 219 receive and store the search results in the found profiles database 218 and display the search results on the UI 212. The direct channel process subroutine 205 is for receiving the search results from the direct channel 141. And search result analyzer 219 is for receiving the search results from the web server 135.

Refining

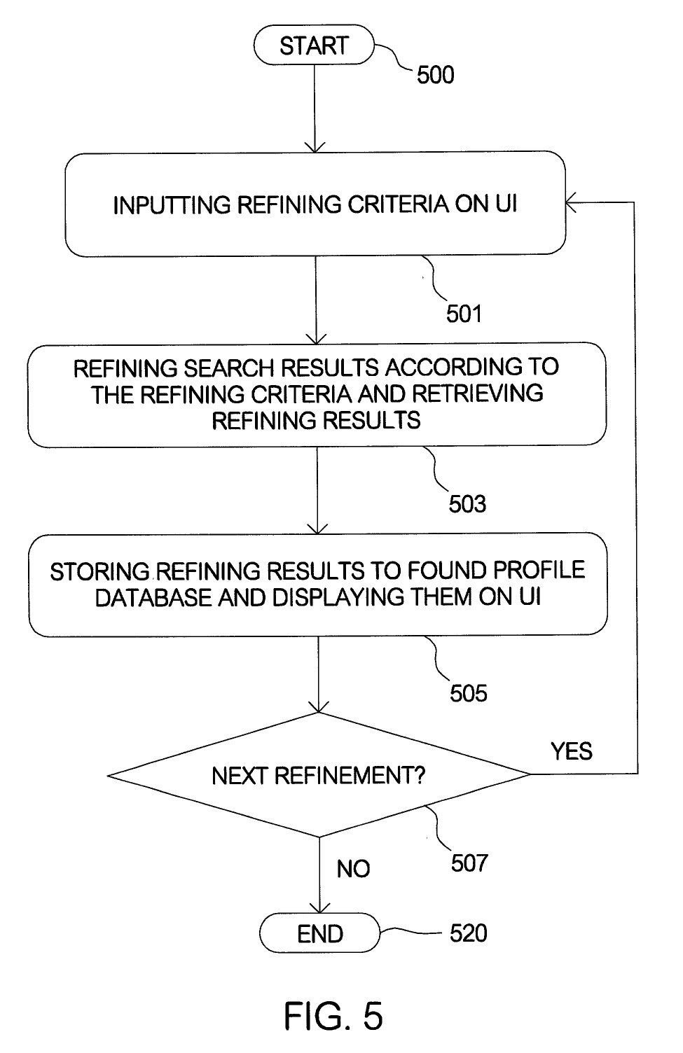

The refining method can be applied to further refine the search results. Please refer to FIG. 5. FIG. 5 illustrates the flowchart of the method for refining. The method begins with the step 501. At the step 501, user A inputs refining criteria on the UI 212. Next, at the step 503, search refining subroutine 217 refines the search results according to the refining criteria and retrieves refining results. The search results can be retrieved from relationship-searching websites or from the found profile database 218.

Next, at the step 505, the search refining subroutine 217 stores the refining results in the found profile database 218 and displays the refining results on the UI 212. Then the method proceeds to the step 507. At the step 507, the search refining subroutine 217 asks user A whether to proceed to next refinement. If yes, the method proceeds to the step 501. If not, the method ends.

In addition, after searching or refining matched results, user A can selectively store some of search results or refining results in the my-favorite database 201. That is, preferred matched users can be selected to remove from the found profile database 218 and store in the my-favorite database 201 by user A.

On-Line Searching

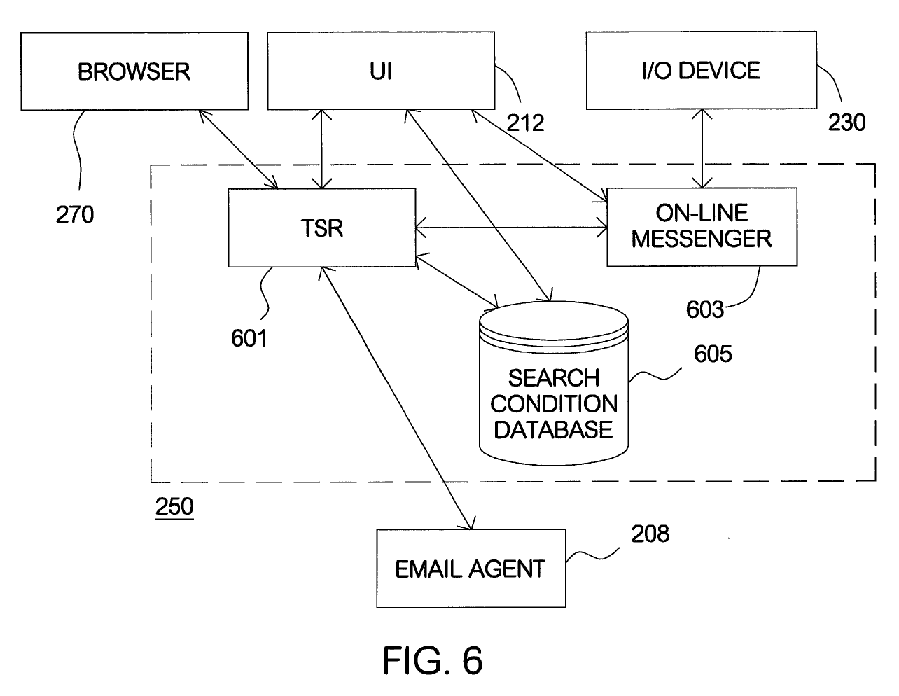

In FIG. 2, the system for registering and searching in multiple relationship-searching websites even includes the on-line search unit 250. The on-line search unit 250 is for searching an matched user who is on-line at the same time from the relationship-searching website 111 and providing on-fine contact to the on-line matched user. Simultaneously referring to FIG. 6, FIG. 6 shows the block diagram of the on-line search unit 250 in FIG. 2. In FIG. 6, the on-line search unit 250 includes a TSR (terminate-and-stay-resident) 601, on-line messenger 603 and search condition database 605. The TSR 601 is for connecting the direct channel 141 to access the personal profile database 133 via the network 110. The TSR 601 is a process and always resides in the operation system (OS) of the computer 101. The OS could be MS-Windows 95, 98, OS2, Linux, and so on. The search condition database 605 is for storing on-line search conditions. And the on-line messenger 603 is for building on-line communication to an on-line matched user.

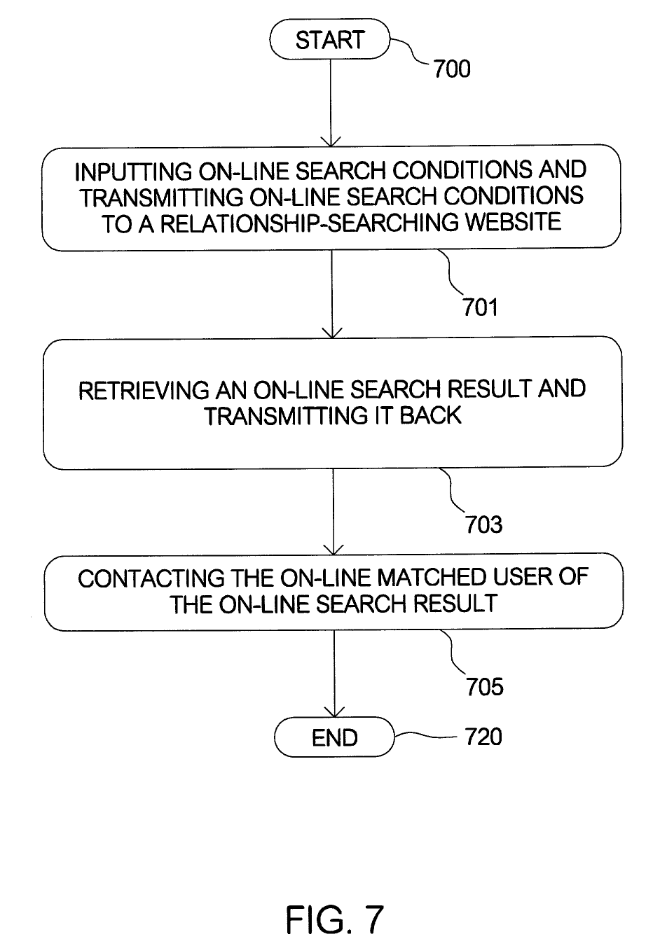

Please refer to FIG. 7 in the meantime. FIG. 7 illustrates the flowchart of the method for on-line search. In FIG. 7, the method begins with the step 701. At the step 701, user A inputs on-line search conditions for looking for an matched user who is on line at the same time. And the on-line search conditions are transmitted to the relationship-searching website 111. Wherein, user A can input the on-line search conditions through the UI 212 or TSR 601. Besides, the on-line search conditions are stored in the search conditions database 605.

Next, at the step 703, the direct channel 141 of the website 111 receives the on-line search conditions and retrieves an on-line search result from the personal profile database 133. And the on-line search result is transmitted back to the TSR 601 and displayed on the UI 212 of the computer 101. Then, the method proceeds to the step 705. Next, at the step 705, the user contacts an on-line matched user of the on-line search result by the on-line messenger 603 or an email. The on-line matched user is supposed a user B who uses a search software 123 to connect to the website 111 in a computer 103. If user A chooses off-line contact to the user B, the TSR 601 triggers an email agent 208 to serve user A. The email agent 208 could be Microsoft Outlook, Netscape Messenger or Qualcomm Eudora, and so on. If user A chooses on-line contact to user B, the on-line messenger 603 is triggered to build a connection to an on-line messenger (not shown in FIG. 6) of the search software 123 of the computer 103.

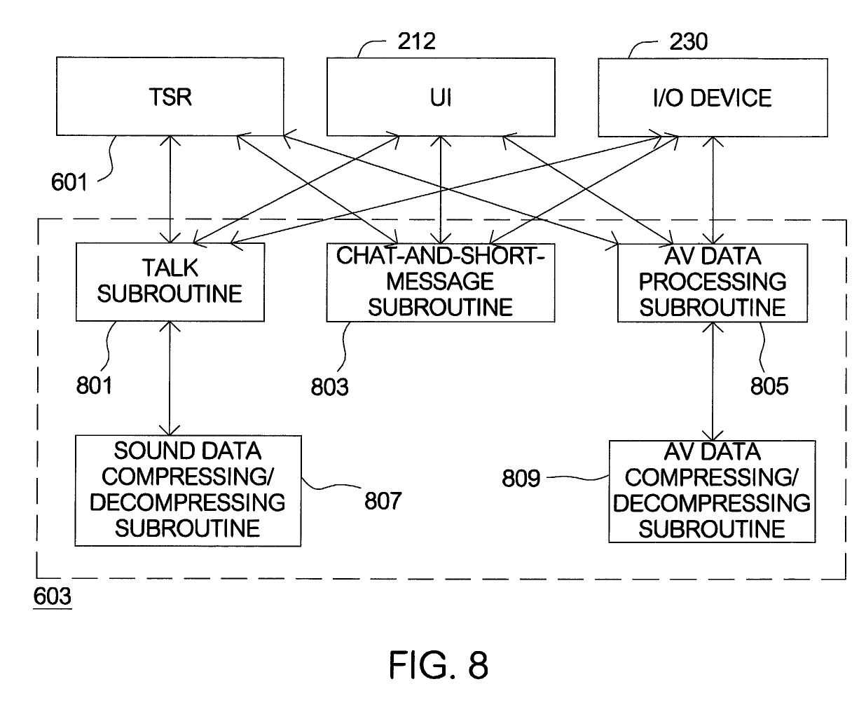

Please simultaneously refer to FIG. 8. FIG. 8 shows the block diagram of the on-line messenger 603 in FIG. 6. The on-line messenger 603 includes a talk subroutine 801, chat-and-short-message subroutine 803, AV (audio and video) data processing subroutine 805, sound data compressing/decompressing subroutine 807 and AV data compress/decompressing subroutine 809. User A can choose one of the following five ways to contact user B.

(1) Talking

User A can talk to user B by a microphone (not shown in FIG. 8) of the I/O device 230. When starting to talk, the TSR 601 triggers the talk subroutine 801 to receive sound data from the microphone. And the talk subroutine 801 transmits the sound data to the sound data compressing/decompressing subroutine 807 to convert and compress the sound data to network transferable data. Then the subroutine 807 transmits the compressed sound data to a sound data compressing/decompressing subroutine (not shown in FIG. 8) of the search software 123 of the computer 103 through the network 110. The sound data compressing/decompressing subroutine of the search software 123 decompresses the compressed sound data and transmits it to the talk subroutine (not shown in FIG. 8) of the search software 123. At last, the talk subroutine of the search software 123 plays sound of user A by a speaker of the I/O device of the computer 103.

(2) Chatting

User A can interactively chat with the user B by typing. The TSR 601 triggers the chat-and-short-message subroutine 803 to build a connection to a chat-and-short-message subroutine (not shown in FIG. 8) of the search software 123 of the computer 103 via the network 110. Then user A and user B can start to interactively chat through the connection.

(3) Sending Short Messages

User A can send messages to user B by typing. The TSR 601 triggers the chat-and-short-message subroutine 803 and the subroutine 803 builds a connection to the chat-and-short-message subroutine of the search software 123 via the network 110. Then user A and user B can start to send short messages to each other through the connection.

(4) Talking Face To Face

User A can talk to user B face to face by using a microphone and a video camera of the I/O device 230. When starting to talk, the TSR 601 triggers the AV data processing subroutine 805 to receive audio and video data by the microphone and the video camera. And the AV data processing subroutine 805 transmits the sound and video data to the AV data compressing/decompressing subroutine 809 to convert and compress the data to network transferable data. Then the subroutine 809 transmits the data to an AV data compressing/decompressing subroutine (not shown in FIG. 8) of the search software 123 of the computer 103 via the network 110. The AV data compressing/decompressing subroutine of the search software 123 decompresses the data and transmits it to an AV data processing subroutine (not shown in FIG. 8) of the search software 123. At last, the AV data processing subroutine of the search software 123 plays sound and video of user A to the user B via a speaker and a monitor of the I/O device of the computer 103. In reverse direction it works with the same method.

(5) Sending An Email

User A can send an email to user B. The TSR 601 triggers the email agent 208 for user A to draft an email. And then the email agent 208 sends the email to the user B.

Further, all emails, chat content, short messages, talk records, and AV data can be stored in the my-favorite database 201 or the found profile database 218.

Email Analyzing

In general, relationship-searching websites (website 111 and website 113) provide service with sending an up-to-date or newly matched user profile reports to every member with an email periodically or non-periodically. This service is very convenient for members to obtain newly data of matched members instead of searching in these websites. Besides, a user usually owns several accounts of these relationship-searching websites and these websites send emails to make sure or notify new states of these accounts. Furthermore, there are many emails from other members. Therefore the system provides the email analyzing unit 260 to aid a user to maintain and check emails.

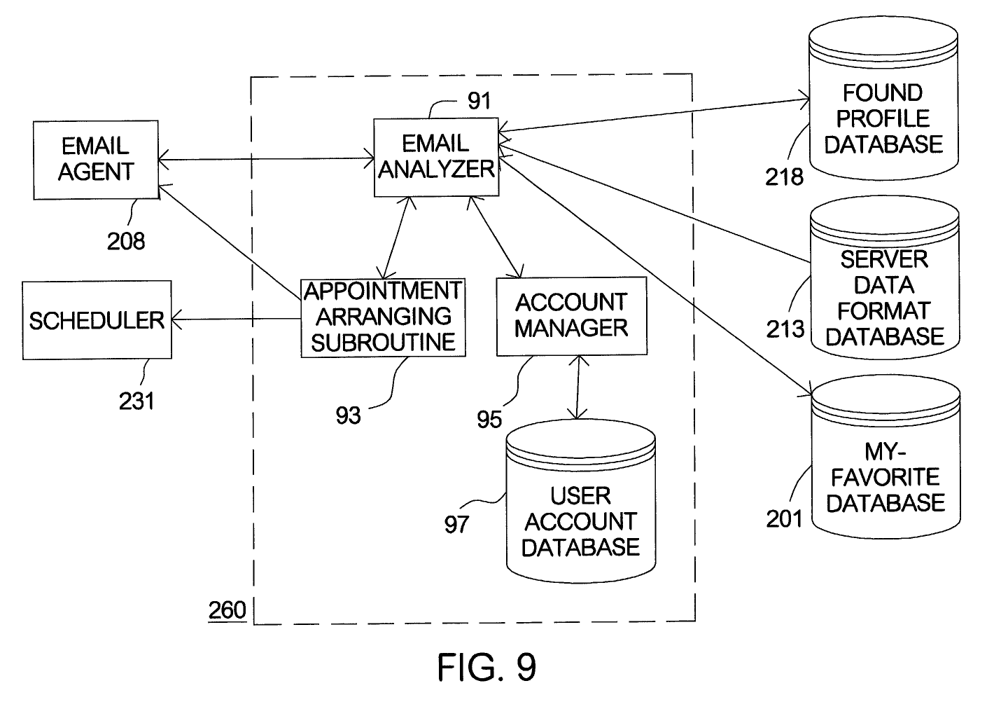

Referring to FIG. 2, the email analyzing unit 260 is for checking emails. Please refer to FIG. 9. It illustrates the block diagram of the email analyzing unit 260 in FIG. 2. In FIG. 9, the email analyzing unit 260 comprises an email analyzer 91, appointment arranging subroutine 93, account manager 95 and user account database 97. The email analyzer 91 is for monitoring the email agent 208 and checking emails. The account manager 95 is for maintaining states of accounts of website 111 and website 113. The user account database 97 is for storing related data of accounts. And the appointment arranging subroutine 93 is for connecting to a scheduler 231 to arrange appointments.

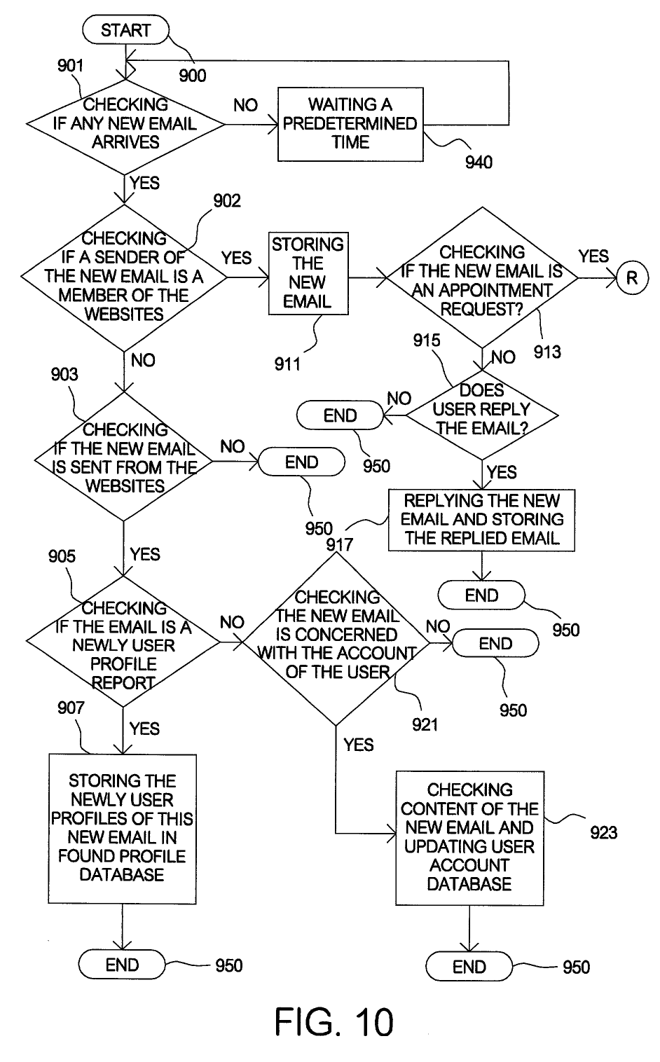

Please refer to FIG. 10. It shows the flowchart of the method for checking emails. In FIG. 10, the method begins with the step 901. At the step 901, the email analyzer 91 monitors the email agent 208 and checks if any new email arrives. If yes, the method proceeds to the step 902, otherwise proceeds to a step 940.

At the step 940, the email analyzer 91 waits a predetermined time and then proceeds to the step 901 to check arrival of a new email again. The predetermined time can be defined by user A and it can be five minutes or ten minutes. Next, the method proceeds to the step 901.

At the step 902, the email analyzer 91 checks whether a sender of a new email is a member of the website 111 or website 113. If yes, the method proceeds to the step 911 or else proceeds to the step 903. The sender of this new email is supposed to user B who uses the computer 103. In this step, domain of an email address of the sender can be checked if it is one of the website 111 or website 113.

At the step 911, the email analyzer 91 stores the new email and notifies user A on the UI 212. Wherein the new email can be stored in email history of user B of the my-favorite database 201 or the found profile database 218.Next, the method proceeds to the step 913.

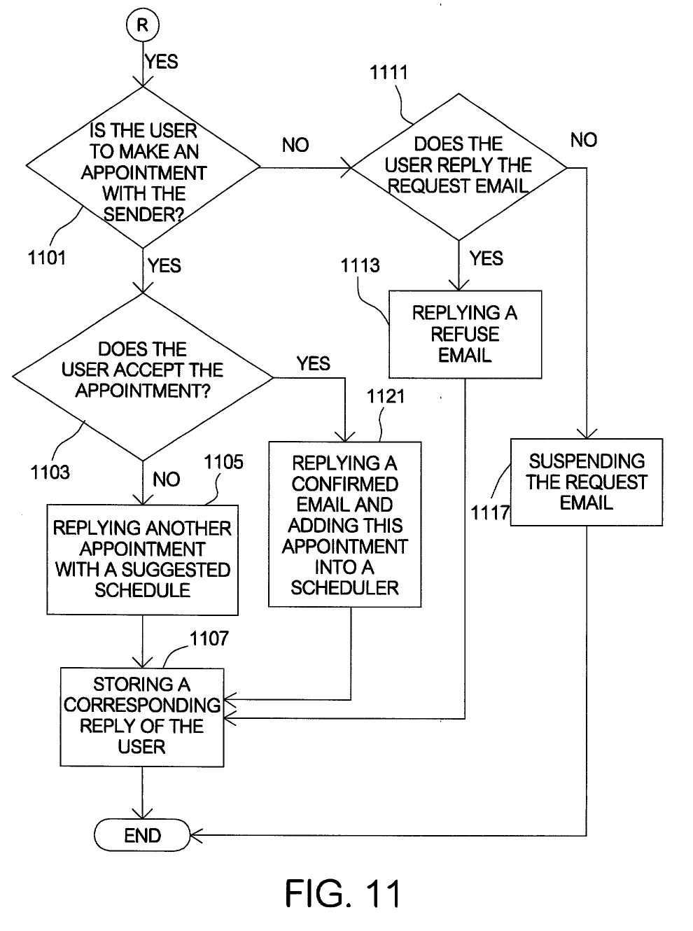

At the step 913, the email analyzer 91 analyzes the email and checks whether it is an appointment request. If yes, the method proceeds to a node R to further proceed the method for arranging an appointment, otherwise proceeds to the step 915. The method for arranging an appointment is shown in FIG. 11 and described later.

At the step 915, the email analyzer 91 asks user A whether to reply the email to user B. If yes, the method proceeds to the step 917. If no, the method ends.

At the step 917, user A replies the email and the email analyzer 91 stores the replied email. Wherein the replied email can be stored in the my-favorite database 201 or found profile database 219.

At the step 903, the email analyzer 91 checks whether the new email is sent from relationship-searching websites, website 111 or website 113. If yes, the method proceeds to the step 905, otherwise the method ends.

At the step 905, the email analyzer 91 checks if the email is a newly user profile report. If yes, the method proceeds to the step 907. Otherwise the method proceeds to the step 921.

At the step 907, the email analyzer 91 stores the newly user profiles of this new email in the found profiles database 218 and display them on UI 212. Then the method ends.

At the step 921, the email analyzer 91 checks if the new mail is concerned with an account of user A. If yes, the method proceeds to the step 923. Otherwise it ends.

At the step 923, the email analyzer 91 triggers the account manager 95 to analyze the email and to update in the user account database 97. Then the method ends.

Appointment Arranging

In addition, the system for registering and searching in multiple relationship-searching websites provides user A with making an appointment by emails. It can also automatically add confirmed appointments into a scheduler if any scheduler is installed.

Please refer to FIG. 11. It illustrates the flowchart of the method for arranging an appointment. After proceeding of the node R of FIG. 10, the method begins with the step 1101.

At the step 1101, the appointment arranging subroutine 93 asks if user A is to make an appointment with user B, the sender of this new email. If yes, the method proceeds to the step 1103. Otherwise it proceeds to the step 1111.

At the step 1103, the appointment arranging subroutine 93 asks user A whether to accept the appointment after the appointment arranging subroutine 93 analyzes content of the email. If user A accepts this appointment, the method proceeds to the step 1121. Otherwise, it proceeds to the step 1105.

At the step 1105, user A replies another appointment with suggested schedule by the email agent 208 triggered from the appointment arranging subroutine 93. Then the method proceeds to the step 1107.

At the step 1107, the appointment arranging subroutine 93 stores a corresponding rely of the user in email history of user B of the my-favorite database 201 or found profile database 218. And the method ends.

At the step 1121, user A replies a confirmed email to user B and the appointment arranging subroutine 93 adds the appointment into the scheduler 231. Then the method proceeds to the step 1107.

At the step 1111, the appointment arranging subroutine 93 asks user A whether user A wants to reply the request. If yes, the method proceeds to the step 1113. Otherwise it proceeds to the step 1117.

At the step 1113, user A replies a refuse email to the sender of the request email and the method then proceeds to the step 1107. Wherein, user A can use the email agent 208 triggered by the appointment arranging subroutine 93 to reply the refuse email. Additionally, user A can also use the appointment arranging subroutine 93 to automatically reply a default refuse email.

At the step 1117, the appointment arranging subroutine 93 suspends the request email.

Browser

Referring to FIG. 1, FIG. 2 and FIG. 6, if user A uses the browser 270 to connect to these relationship-searching websites, the TSR 601 monitors actions of the browser 270.

(1) Searching

When user A is searching on the website 111 by the browser 270, the TSR 601 detects search action and produces a pop-up window to ask user A whether to search all relationship-searching websites. If the answer is yes, the TSR 601 analyzes search criteria user A inputted on website 111 through browser 270 and sends the search criteria to the search poster 216. The search poster 216 further asks user A whether to change the search criteria. If the answer is yes, the search poster 216 lets user A change the search criteria through the UI 212. Next, the search poster 216 begins to searches all relationship-searching websites. The search process is the same as the above described.

(2) Registration or Modification of User's Profile

When user A is registering or modifying his user profile on the website 111, the TSR 601 detects action of registration and produces a pop-up window to ask user A whether to register or change his own personal profile on all relationship-searching websites. If the answer is yes, the TSR 601 analyzes the user profile user A inputted on the website 111 through browser 270 and sends the user profile to the profile poster 214. The profile poster 214 further asks user A whether if he wants to change his personal profiles. If the answer is yes, the profile poster 214 lets user A modify the profile through the UI 212. Next, the profile poster 214 registers or modifies personal profile of user A in all relationship-searching websites. The process of registering, posting or personal profile is the same as the above described.

(3) Add a New Website

When user A finds a new relationship-searching website not included in the server data format database 213, user A can press the “Add New Relationship-Searching Website” button. Then the software grabs the address of the new website in the browser and asks user A if the address is the new website. If yes, the address will be sent to the system management department or representative by an email.

In the above description of the preferred embodiment, the invention is illustrated by taking the connection to two relationship-searching websites (i.e. website 111, 113) as an example, but it is to be understood that the invention is not limited thereto. The connection to multiple relationship-searching websites is also an application of the invention.

### EXAMPLE TWO

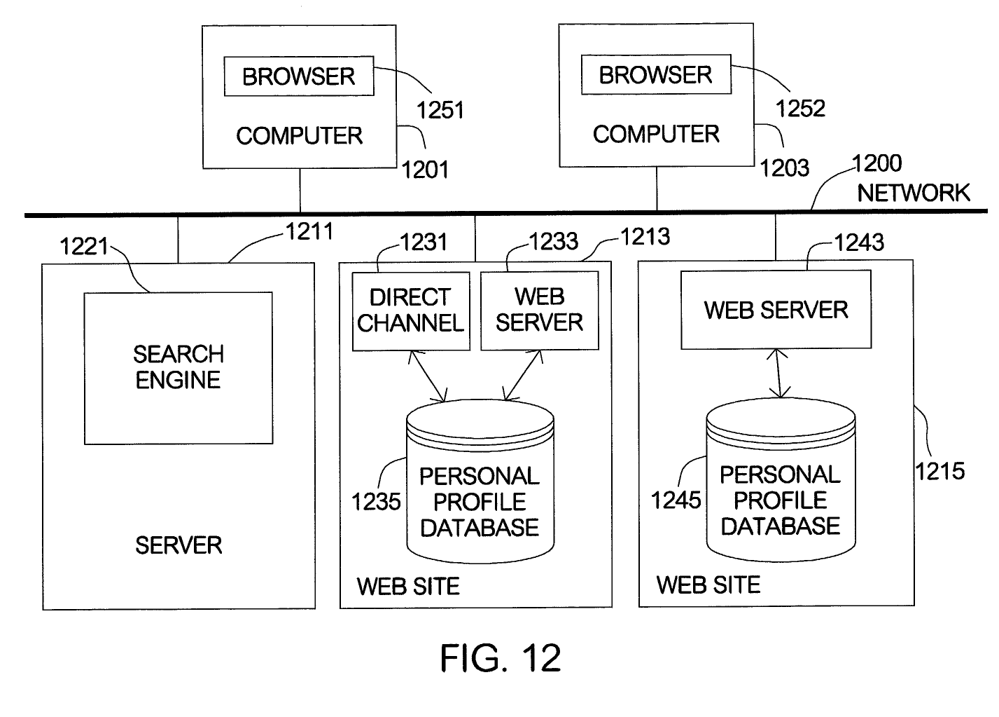

It is different but similar to implement the search engine on server side than search software on client side. Please refer to FIG. 12. FIG. 12 shows the network computer system block diagram of the system for registering and searching in multiple relationship-searching websites according to the example two of the preferred embodiment of the invention. In FIG. 12, a website 1213 and website 1215 are relationship-searching websites, such as marriage-searching websites, friendship-searching websites, partnership-searching websites or romance-searching websites. The website 111 and website 113 provide service of registration and searching matched users.

The website 1213 includes a web server 1233 and a personal profile database 1235 and website 1215 includes a web server 1243 and a personal profile database 1245. The web server 1233 and web server 1243 are for providing users with service of registration and searching. And the personal profile database 1235 and personal profile database 1245 are for storing user profiles. The website 1215 is a common relationship-searching website. And the relationship-searching website 1213 further includes a direct channel 1231. The direct channel 1231 is for providing an interface to fast access the personal profile database 1235.

This system of the invention includes a search engine 1221 which is installed on a server 1211. The search engine 1221 is for providing users with registering and searching matched users in multiple websites, such as the website 1213 and website 1215.

In FIG. 12, a computer 1201 and computer 1203 connect to the server 1211, the website 1213 and website 1215 via a network 1200. In the computer 1201 and computer 1203, users can use browser 1251 and browser 1252 to connect to the server 1211, the website 1213 and the website 1215 and execute functions of the server 1211.

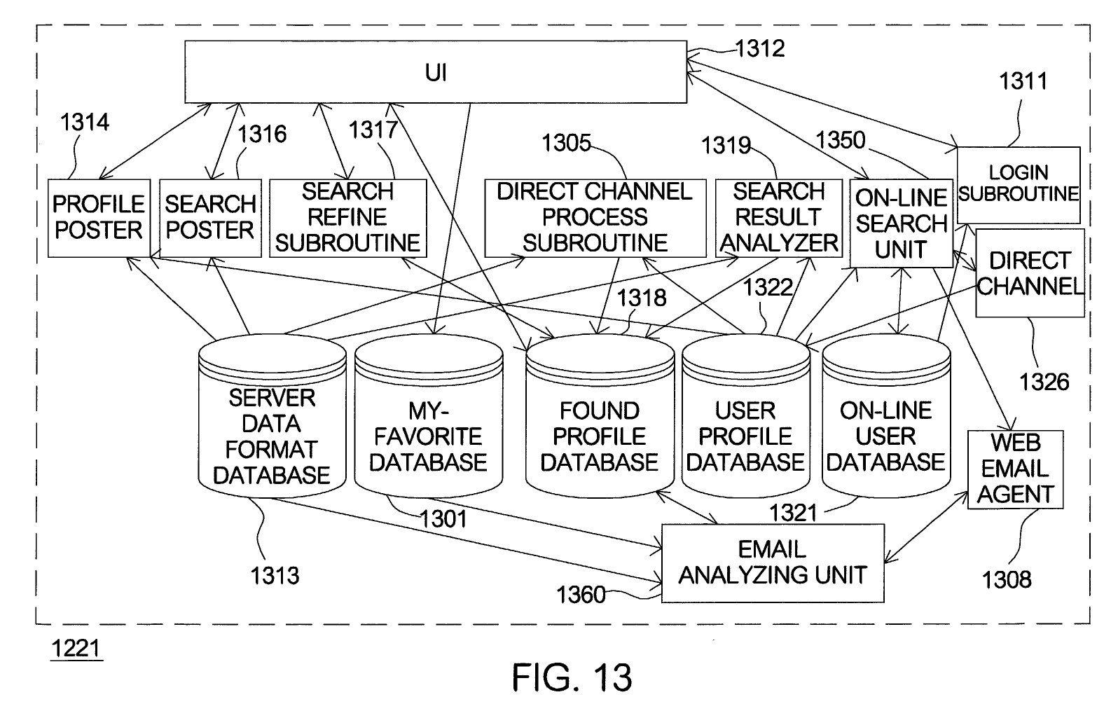

Referring to FIG. 13, it illustrates the system block diagram of the search engine 1221 of the server 1211 in FIG. 12. In FIG. 13, a user interface (UI) 1312 is for users to control the system. And the UI 1312 can be a graphical user interface generally provided by web server. A user profile database 1322 is used for storing user profiles. A search poster 1316 provides users with searching in multiple websites and a search refine subroutine 1317 can further refine search results. A direct channel process subroutine 1305 and search result analyzer 1319 are for receiving search results from websites. And the format of search results can be the hypertext markup language (HTML), extensible markup language(XML), or other languages. A found profiles database 1318 is for storing search results. And the found profile database 1318 can be built on memory, disk or any storage device. A my-favorite database 1301 is for users to selectively store the search results. A server data format database 1313 is for storing data format of registration and search service of multiple relationship-searching websites. And it provides corresponding data format of every relationship-searching website for the profile poster 1314, search poster 1316, direct channel process subroutine 1305 and search result analyzer 1319. So, the server data format database 1313 has to be regularly updated when a new relationship-searching website produces or another one changes its data format.

In addition, the search engine 1221 even includes a login subroutine 1311, on-line user database 1321, on-line search unit 1350, direct channel 1326, email analyzing unit 1360 and web email agent 1308. The on-line user database 1321 is for recording users who is on line at the same time. The login subroutine 1311 is for providing users to register, log-in and log-off in the search engine 1221. And when users log-in or log-off, the login subroutine 1311 updates the on-line user database 1321 and the user profile database 1322. The on-line search unit 1350 is for searching an on-line matched user from the on-line user database 1321. The direct channel 1326 is for providing a faster connection to the on-line search unit 1350. The email analyzing unit 1360 is for checking a new email received by the web email agent 1308. Please refer the following description in detail. At first, it is supposed that user A uses the computer 1201 to connect to the search engine 1221.

Registration Or Modification Of User's Profile

If user A registers to the server 1211, the login subroutine 1311 of the search engine 1221 requests him to fill data columns of his user profile on the UI 1312. And then his user profile is stored in the user profile database 1322. When user A logs on the search engine 1221, his account or name is added into the on-line user database 1321. Inversely, when user A logs off, his is removed from the on-line user database 1321 immediately. Besides, the flowchart of the method for registering and modifying profiles in multiple relationship-searching websites is the same with FIG. 3 and the description of this method is similar with the above.

Searching

After user A has logged in the search engine 1221, he can execute the search service to search matched users from multiple relationship-searching websites, such as the website 1213 and website 1215. The flowchart of the method for searching matched users from multiple websites is the same with FIG. 4. And the description of this method is similar with the above.

Refining

The refining method can be applied to further refine the search results by the user A. The flowchart of the method for refining is the same with FIG. 5. So, process of this method does not be stated here.

On-line Searching

In FIG. 13, the system for registering and searching in multiple relationship-searching websites even includes the on-line search unit 1350. The on-line search unit 1350 is for searching an on-line matched user and providing on-line contact to the on-line matched user. There are two or more alternative ways to implement on-line search. Here describes two of them.

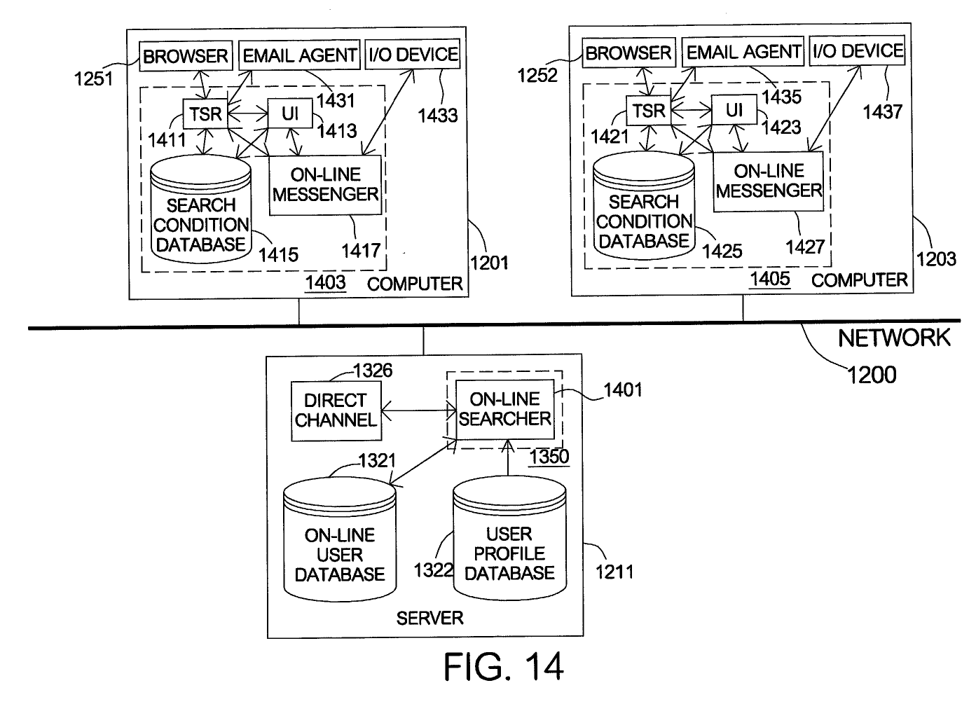

(a) Simultaneously referring to FIG. 14, FIG. 14 shows the network system block diagram of the first on-line search method. In FIG. 14, the on-line search unit 1350 includes an on-line searcher 1401. The on-line searcher 1401 is for retrieving an on-line matched user from the on-line user database 1321 and user profile database 1322. Besides, the system of this embodiment includes an on-line search client unit 1403 which is installed in the computer 1201. The on-line search client unit 1403 is for connecting to the on-line searcher 1401 to search the on-line matched user.

The on-line search client unit 1403 includes a TSR (terminate-and-stay-resident) 1411, UI 1413, on-line messenger 1417 and search condition database 1415. The UI 1413 is for providing user A with an interface to control the on-line search client unit 1403. The TSR 1411 is for connecting to the on-line searcher 1401 via the direct channel 1326. The TSR 1411 is a process and always resides in the operation system (OS) of the computer 101. The OS could be MS-Windows 95, 98, OS2, Linux, and so on. The search condition database 1415 is for storing on-line search conditions. And the on-line messenger 1417 is for building on-line communication to an on-line matched user.

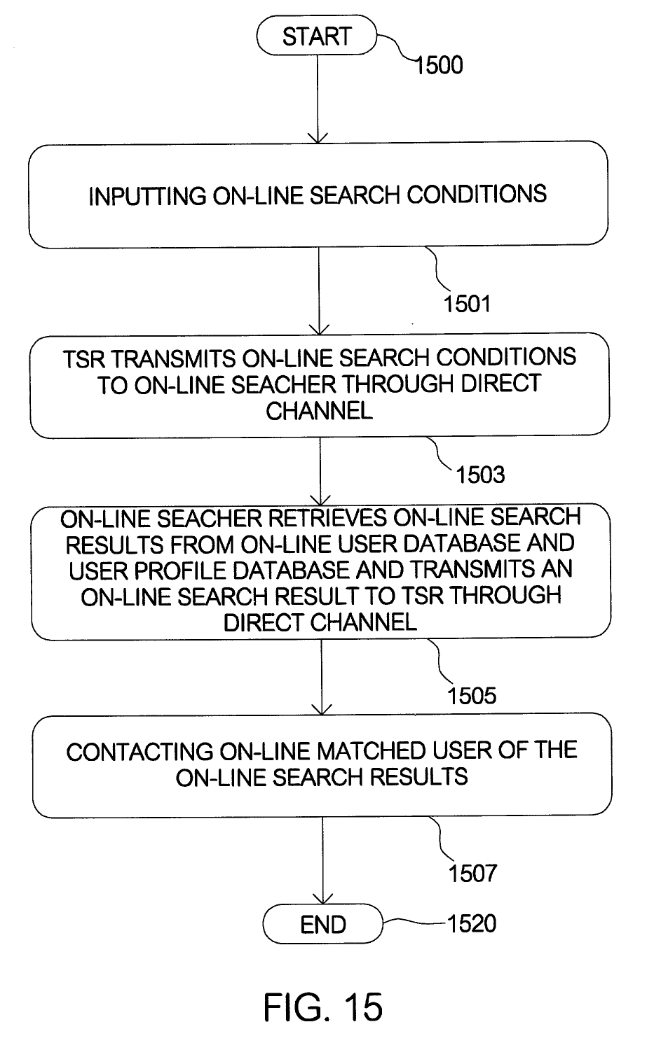

Please refer to FIG. 15 in the meantime. FIG. 15 illustrates the flowchart of the method for on-line search. In FIG. 15, the method begins with the step 1501. At the step 1501, user A inputs on-line search conditions for looking for an on-line matched user who is on line at the same time. User A can set the on-line search conditions through the UI 1413 or TSR 1411. Besides, the on-line search conditions are stored in the search conditions database 1415.

Next, at the step 1503, the TSR 1411 transmits the on-line search conditions to the on-line searcher 1401 through the direct channel 1326 of the server 1211. And then the method proceeds to the step 1505.

At the step 1505, the on-line searcher 1401 retrieves an on-line search result from the on-line user database 1321 and user profile database 1322, and transmits the on-line match result back to the TSR 1411 through the direct channel 1326. Wherein, an on-line matched user of the on-line matched result is on line and allows others contact him. The on-line search result can be displayed on UI 1413. Then, the method proceeds to the step 1507.

Next, at the step 1507, user A contacts the on-line matched user by the on-line messenger 1417 or an email. The user can select on-line or off-line way to contact to one of matched members, said user B in the computer 1203. And it is supposed that an on-line search client unit 1405 is installed in the computer 1203.

If user A chooses off-line contact to the user B, the TSR 1411 triggers an email agent 1431 to serve user A. The email agent 1431 could be Microsoft Outlook, Netscape Messenger or Qualcomm Eudora ... and so on. If user A chooses on-line contact to user B, the on-line messenger 1417 builds a connection to the on-line messenger 1427 of the computer 1203. And in order to on line contact user A, an on-line search client unit 1405 has to be installed on the computer 1203.

The block diagram of the on-line messenger 1417 is the same with FIG. 8. The on-line messenger 1417 includes a talk subroutine, chat-and-short-message subroutine, AV (audio and video) data processing subroutine, sound data compressing/decompressing subroutine and AV data compress/decompressing subroutine. User A can contact user B by one of the following five ways: talking, chatting, sending short messages, talking face to face and sending an email. Processes of these five ways of the on-line messenger 1417 can be referred as the above and does not be stated again.

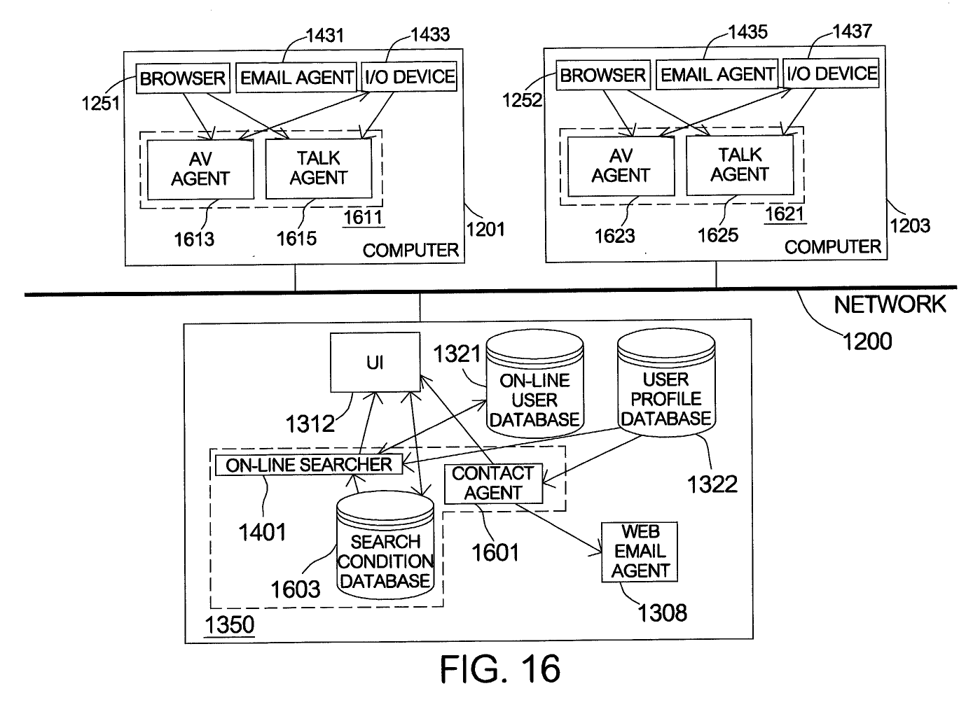

(b) The alternative way of on-line search is depicted in FIG. 16. FIG. 16 is the network block diagram for the second on-line searching method. In FIG. 16, the on-line search unit 1350 includes an on-line searcher 1401, a contact agent 1601 and a search condition database 1603. The on-line searcher 1401 is for retrieving an on-line matched user from the on-line user database 1321 and user profile database 1322. The contact agent 1601 is for retrieving an internet protocol (IP) address of the on-line matched user from the user profile database 1322. And the search condition database 1603 is for storing on-line search conditions.

Besides, the system of this embodiment includes an on-line contact client unit 1611, which is installed in the computer 1201. The on-line contact client unit 1611 is for building a connection to other computers. The on-line contact client unit 1611 includes an AV (audio and video) agent 1613 and talk agent 1615. The AV agent 1613 is for processing, compressing and decompressing audio and video data. And the talk agent 1615 is used for processing, compressing and decompressing sound data.

At first, user A inputs on-line search conditions on the UI 1312 via a browser 1251. Then the UI 1312 triggers the on-line searcher 1401 to retrieve an on-line search result from the on-line user database 1321 and user profile database 1322 according to the on-line search conditions. An on-line matched user of the on-line search result can be displayed on the UI 1312 to user A. Suppose that the on-line matched user is user B and user B uses the computer 1203. And an on-line contact client unit 1621 is installed on the computer 1203. And user A can use the following ways to contact user B.

(1) Talking

Although the browser 1251 does not provide a function of converting between sound data and network transferable data, the talk agent 1615 is for dealing with sound data in the computer 1201. When user A wants to talk with user B, the UI 1312 triggers the contact agent 1601 to retrieve the IP address of user B from the user profile database 1322. The contact agent 1601 transmits the IP address of user B to the talk agent 1615 and sends the talking agent 1625 the request message that user A wants to talk with user B. After user B agrees to talk with user A, the contact agent 1601 transmits the IP address of user A to the talk agent 1625 and the talk agent 1615 builds a connection to the talk agent 1625. And then user A can talk with user B each other via speakers and microphones of the I/O device 1433 and I/O device 1437. Wherein, the contact agent 1601 even includes a talk subroutine (not shown in FIG. 16) which is used for implementing the above mentioned functions.

(2) Chatting Or Sending Short Messages

User A can interactively chat with user B or send short messages to him through the browser 1251. The UI 1312 triggers the contact agent 1601 to alarm a browser 1252 that user B use in the computer 1203. Then user A and user B can chat with each other and send short message to each other via the browser 1251 and browser 1252. Wherein, the contact agent 1601 even includes a chatting and short messaging agent (not shown in FIG. 16) which is used for implementing the above mentioned functions.

(3) Talking Face To Face

Although the browser 1251 does not provide a function of converting between AV data and network transferable data, the AV agent 1615 is used for dealing with AV data in the computer 1251. User A can talk to user B face to face by using a microphone and a video camera (not shown in FIG. 16) of the I/O device 1430. The UI 1312 triggers the contact agent 1601 to retrieve the IP (internet protocol) address of user B from the personal profile database 1322. The contact agent 1601 transmits the IP address of user B to the AV agent 1613 and send the AV agent 1623 of the computer 1203 the request message that user A wants to talk with user B face to face. After user B agrees to talk with user A, the contact agent 1601 transmits the IP address of user A to the talk agent 1623 and the AV agent 1613 builds a connection to the AV agent 1625. And then user A can talk with user B each other via speakers, microphones, video cameras and monitors of the I/O device 1433 and I/O device 1437. Wherein, the contact agent 1601 even includes an AV data processing subroutine (not shown in FIG. 16) which is used for implementing the above mentioned functions.

(4) Sending An Email

User A can use an off-line way to contact user B by sending an email. The UI 1312 triggers the contact agent 1601 to retrieve an email address of user B from the user profile database 1322. And the contact agent 1601 transmits the email address to the browser 1251. Then the browser 1251 triggers an email agent 1431 to serve user A in the computer 1201. Besides, to use the web mail agent 1308 of the search engine 1221 is alternative more private method. After the contact agent 1601 retrieves the email address of user B, the web email agent 1308 is triggered to serve user A. Wherein, the contact agent 1601 even includes an email address retrieving subroutine (not shown in FIG. 16) which is used for implementing the above mentioned functions.

Email Analyzing

In general, relationship-searching websites provide service with sending an up-to-date or newly matched user profile report to their every member with an email periodically or non-periodically. This service is very convenient for members to obtain newly matched users instead of searching in these websites. Besides, a user usually owns several accounts of these relationship-searching websites and these websites send emails to make sure or notify new states of these accounts. Furthermore, there are many emails from other members. Therefore the system provides the email analyzing unit 1360 to aid users to maintain and check emails if users use the web email agent 1308 of the search engine 1221 to receive and send their emails.

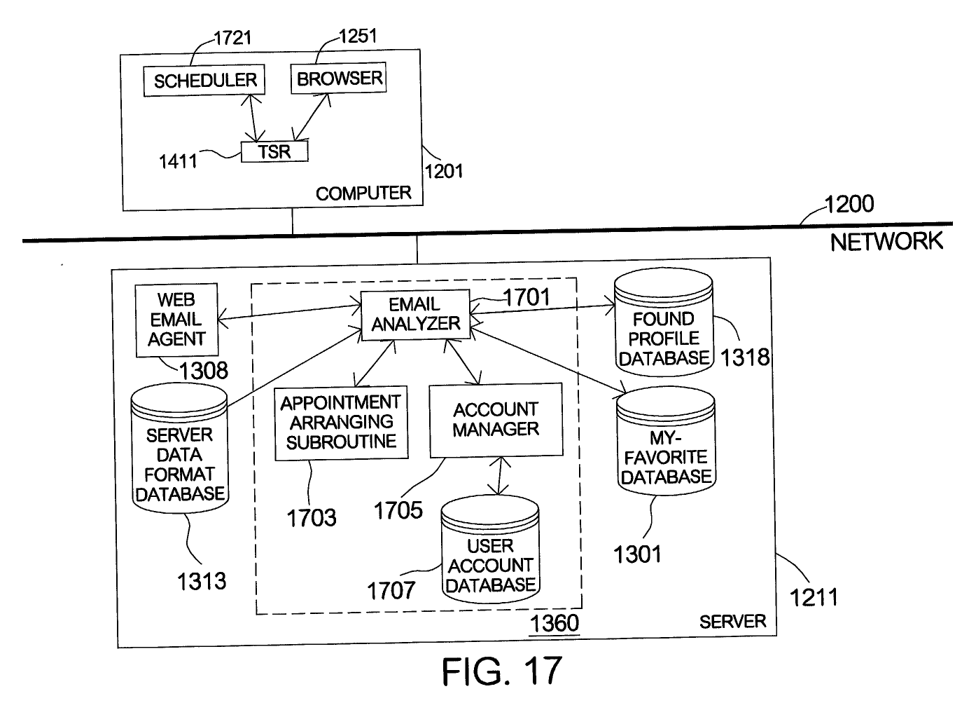

Referring to FIG. 13, the email analyzing unit 1360 is for checking emails from multiple relationship-searching websites. Please refer to FIG. 17. It illustrates the block diagram of the email analyzing unit 1360 in FIG. 13. In FIG. 17, the email analyzing unit 1360 includes an email analyzer 1701, appointment arranging subroutine 1703, account manager 1705 and user account database 1707. The email analyzer 1701 is for monitoring the web email agent 1308 and analyzing emails. The account manager 1705 is for maintaining states of accounts of websites. The user account database 1707 is for storing related data of accounts. And the appointment arranging subroutine 1703 is for connecting to a scheduler 231 to arrange appointments.

The flowchart of the method for analyzing emails is the same with FIG. 10. In FIG. 17, the email analyzer 1701 monitors any new email received by the web email agent 1308 in the server 1211. So, processes of this method is not to be stated again here.

Appointment Arranging

In addition, the system for registering and searching in multiple relationship-searching websites provides users with making an appointment by web emails. It can also automatically add confirmed appointments into a scheduler 1721 if any scheduler is installed. The flowchart of the method for arranging an appointment is the same with FIG. 11. In FIG. 17, the appointment arranging subroutine 1703 connects to the scheduler 1721 via the TSR 1411. Process of this method will not be stated again.

Browser

If user A is using a relationship-searching website, such as the website 1213 or website 1215, by the browser 1251, the search engine 1221 may provide a function that responds to user A's action on websites. The function may comprise of the following sub functions:

(1) Searching

When the search poster 1316 receives the user A's searching on the website 1213, the search poster 1316 will show a pop-up message on the UI 1312 to ask user A if he wants to search all websites. If the answer is yes, the search poster 1316 asks user A if he wants to change the search criteria. If the answer is yes, the search poster 1316 will let user A to change the search criteria through UI 1312. Then the search poster 1316 will search all relationship-searching websites included in the server data format database 1313 for user A. The search process is the same as the process described in the above.

(2) Registration or Modification of User Profile

When user A is registering or updating his own personal profile through the browser 1251 on a relationship-searching website, such as the website 1213, the profile poster 1314 will detect it and show a pop-up message on the UI 1312 to ask user A if he wants to register or update his own personal profile on all relationship-searching websites. If the answer is yes, the profile poster 1314 will ask user A if he wants to change his own inputted personal profiles. If the answer is yes, the profile poster 1314 will let user A to change his personal profile through the UI 1312. Then the profile poster 1314 registers the user As personal profile to or modifies user A's personal profile in all relationship-searching websites included in the server data format database 1313 for user A. The following processes is the same as the process described in the above.

(3) Add a New Website

When user A finds a new relationship-searching website not included in the server data format database 1313, user A can press the “Add New Relationship-Searching Website” button. Then the software grabs the address of the new website in the browser and asks user A if the address is the new website. If yes, the address will be sent to the system management department or representative by an email.

In the above description of the preferred embodiment, the invention is illustrated by taking the connection to two relationship-searching websites (i.e. website 1213, 1215) as an example, but it is to be understood that the invention is not limited thereto. The connection to multiple relationship-searching websites is also an application of the invention. And the example is illustrated by taking the user A as an example, but it is to be understood that the invention is not limited by the connection of a user. Since the system can be installed in a server, the system can provide the connection of multi-users.

Besides, in the above description of the preferred embodiment, the invention is illustrated by taking relationship-searching websites (i.e. website 111, 113, 1213, and 1215) as an example, but it is to be understood that the invention is not limited thereto. Any relationship-searching host to allow a user to register or search for other users is also an application of the invention. The relationship-searching host can be a personal profile database and it operates without a web server and serves with different interface from HTML. However it has similar functions with relationship-searching websites.

In the above description of the preferred embodiment, the invention is illustrated by taking that the network is regarded as a medium of connection between the system and relationship-searching websites as an example, but it is to be understood that the invention is not limited thereto. The system can also connect to relationship-searching hosts via a communication link. And the communication link is any channel or way of wired or wireless communication or data transmission, including but not limited to the network, wireless network, phone line, wired television line, wireless television line, or wireless with any frequency.

In the above description of the preferred embodiment, the invention is illustrated by taking computers (i.e. computer 101, 103, 1201, and 1203) as an example, but it is to be understood that the invention is not limited thereto. Any client terminal that is a device used to connect to relationship-searching hosts via the communication link is also an application of the invention, such as a computer, personal digital assistant (PDA), cellular phone, lined telephone, global position system (GPS) or Web television. As a result, the above description of on-line contact can be further implemented by I-phone technology, for example:

1. Software-to-Phone: On-line contact can be done easily by using I-phone technology and the sound transmission technology.

2. Phone-to-Software: If the client terminal is a cellular phone or lined telephone, the phone can be used to dial to the software directly. The technology is still I-phone technology. In this situation, a prefix of this software is set and each user is given a specific number, and then the user may use the phone to call the software. For example, the prefix of this software is 2345, then the caller may call 2345-xxxxxxxx, the xxxxxxxx is the number of the user whom will be called.

3. Software-to-Software: Mentioned above, it's equal to the online talk function.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for searching in multiple relationship-searching hosts, wherein the relationship-searching hosts allow users to search for other users via a communication link, the system comprising:
a first user interface (ULI) for a user to control the system;
a server data format database for storing data format of search and registration of the relationship-searching hosts;
a search poster for transmitting search conditions, which are inputted via the first UI and are defined by the user, to the relationship-searching hosts with each of the transmitting search conditions' data format retrieved from the server data format database;
a search result analyzer for receiving and analyzing search results from the relationship-searching hosts according to the search conditions with each of data format retrieved from the server data format database; and
a found profile database for storing the search results;
wherein, after the user inputs the search conditions via the first UI, the search poster transmits the search conditions to the relationship-searching hosts; then the relationship-searching hosts receive the search conditions to retrieve the search results and transmit the search results to the search result analyzer; and the search results are stored in the found profile database.

2. The system according to claim 1, wherein the system further comprises:
a profile poster for transmitting a new or modified user profile, which is inputted via the first UI for registering in the relationship-searching hosts, to the relationship-searching hosts with each of the transmitting new or modified profile's data format retrieved from the server data format database; and
a user profile database for storing the new or modified profile.

3. The system according to claim 1, wherein the system further comprises a search refine subroutine for refining the search results.

4. The system according to claim 3 wherein the system further comprises a my-favorite database for the user to selectively store the search results or the refining results.

5. The system according to claim 1, wherein the system further comprises a my-favorite database for the user to selectively store the search results.

6. The system according to claim 1, wherein the system is installed in a client terminal to provide the user to connect the relationship-searching hosts via the communication link.

7. The system according to claim 6, wherein the system further comprises:
a direct channel for being installed in a relationship-searching host to provide a faster connection to access a personal profile database of the relationship-searching host, receiving the search conditions from the search poster, and retrieving the search results according to the search conditions; and
a direct channel process subroutine for being installed in the client terminal to receive the search results through the direct channel.

8. The system according to claim 6, wherein the system further comprises:
a direct channel for being installed in a relationship-searching host to provide a faster connection to access a personal profile database of the relationship-searching host; and
an on-line search unit for being installed in the client terminal for the user to input on-line search conditions, search an on-line matched user in the relationship-searching host and provide on-line contact to the on-line matched user, wherein the on-line search unit comprises:
a TSR (terminate-and-stay-resident), which is a process residing in a operation system (OS) of the client terminal and is for keeping connecting to the personal profile database of the relationship-searching host via the direct channel; and
an on-line messenger for building on-line communication to the on-line matched user;
wherein the user inputs the on-line search conditions via the first UI; the TSR transmits the on-line search conditions to the direct channel; the direct channel retrieves an on-line search result and transmits the on-line search result to the TSR; and the on-line messenger is triggered to build the on-line communication to the on-line matched user of the on-line search result.

9. The system according to claim 8, wherein the system further comprises a search condition database for storing the on-line search conditions.

10. The system according to claim 8, wherein the on-line messenger further comprises:
a sound data compressing/decompressing subroutine for compressing or decompressing and converting between sound data and network transferable data and building a connection to the on-line matched user; and
a talk subroutine for being triggered to receive sound data from a microphone, transmit sound data of the user to the sound data compressing/decompressing subroutine, receive sound data of the on-line matched user from the compressing/decompressing subroutine and play it via a speaker in the client terminal.

11. The system according to claim 8, wherein the on-line messenger further comprises a chat-and-short-message subroutine for building a connection to the on-line matched user, transmitting input of the user and receiving input of the on-line matched user in the connection.

12. The system according to claim 8, wherein the on-line messenger further comprises:
an AV data compressing/decompressing subroutine for compressing or decompressing and converting between audio and video (AV) data and network transferable data and building a connection to the on-line matched user; and
an AV data processing subroutine for being triggered to receive AV data from a microphone and a video camera, transmit AV sound data of the user to the AV data compressing/decompressing subroutine, receive AV data of the on-line matched user from the compressing/decompressing subroutine and play it via a speaker and a monitor in the client terminal.

13. The system according to claim 6, wherein the system further comprises an email analyzing unit for monitoring an email agent installed in the client terminal and checking with a new email received from the email agent, the email analyzing unit comprising:
an email analyzer for monitoring the email agent and checking the new email;
an account manager for managing states of accounts of the user;
a user account database for storing the states of accounts; and
an appointment arranging subroutine for connecting a scheduler of the client terminal to arrange appointments;
wherein, when the new email checked by the email analyzer is concerned with accounts of the user, the account manager is triggered to update states of the accounts in the user account database; and when the new email is concerned with an appointment request, the appointment arranging subroutine is triggered to arrange the request.

14. The system according claim 13, wherein the system checks the content of the new email by a method of the following steps:
a. proceeding step c if the new email arrives, else proceeding step b;
b. waiting a predetermined time and then proceeding the step a;
c. proceeding step d if a sender of the new email is a member of the relationship-searching hosts; or proceeding step g if the new email is sent from the relationship-searching hosts; else ending the method;
d. storing the new email;
e. proceeding step f if the user is to reply the new email, else ending the method;
f. replying the new email and storing a replied email and ending the method;
g. proceeding step h if the email is a newly user profile report; or proceeding step i if the email is concerned with accounts of the user, else ending the method;
h. storing new user profiles of the email in the found profile database and ending the method; and
i. checking the content of the email and updating the user account database.

15. The system according to claim 14, wherein between the step d and e further comprises:
d1 . proceeding step d2 if the new email is an appointment request, else proceeding step e;
d2 . proceeding step d3 if the user is to make an appointment with the sender, else proceeding step d7;
d3 . proceeding step d6 if the user accepts the appointment, else proceeding step d4;
d4. replying another appointment with a suggested schedule;
d5. storing a corresponding reply of the user and ending the method;
d6. replying a confirmed email, adding this appointment into a scheduler, and proceeding the step d5;
d7. proceeding step d8 if the user is to reply the request email, else proceeding step d9;
d8. replying a refuse email and proceeding the step d5; and
d9. suspending the request mail.

16. The system according to claim 6, the client terminal is a computer.

17. The system according to claim 6, the client terminal is a personal digital assistant (PDA).

18. The system according to claim 6, the client terminal is a cellular phone or lined telephone.

19. The system according to claim 1, wherein the system is installed in a server and the user uses a client terminal to connect to the server via the communication link.

20. The system according to claim 19, wherein the system further comprises:
a direct channel for being installed in a relationship-searching host to provide a faster connection to access a personal profile database of the relationship-searching host, receiving the search conditions from the search poster, and retrieving the search results according to the search conditions; and
a direct channel process subroutine for being installed in the server to receive the search results through direct channel.

21. The system according to claim 19, wherein the system further comprises:
a login subroutine for providing the user to register, log in and log off the system;
an on-line user database for recording users who login in the system and are on line;
an on-line searcher for retrieving an on-line matched user from the on-line user database;
a direct channel for providing a faster connection to the on-line searcher; and
an on-line search client unit for being installed in the client terminal for the user to input on-line search conditions, search the on-line matched user from the on-line user database via the direct channel and the on-line searcher and provide on-line contact to the on-line matched user, the on-line search client unit comprises:
a second UI for the user to control the on-line search client unit;
a TSR (terminate-and-stay-resident), which is a process residing in a operation system (OS) of the client terminal and is for connecting to the on-line searcher via the direct channel; and
a on-line messenger for building on-line communication to the on-line matched user;
wherein the user inputs the on-line search conditions via the second UI; the TSR transmits the on-line search conditions to the on-line searcher via the direct channel; the on-line searcher retrieves an on-line search result and transmits the on-line search results to the TSR via the direct channel; and the on-line messenger is triggered to build the on-line communication to the on-line matched user of the on-line search result.

22. The system according to claim 21, wherein the on-line search client unit further comprises a search condition database for storing the on-line search conditions.

23. The system according to claim 21, wherein the on-line messenger further comprises:
a sound data compressing/decompressing subroutine for compressing or decompressing and converting between sound data and network transferable data and building a connection to the on-line matched user; and
a talk subroutine for being triggered to receive sound data from a microphone, transmit sound data of the user to the sound data compressing/decompressing subroutine, receive sound data of the on-line matched user from the compressing/decompressing subroutine and play it via a speaker in the client terminal.

24. The system according to claim 21, wherein the on-line messenger further comprises a chat-and-short-message subroutine for building a connection to the on-line matched user, transmitting input of the user and receiving input of the on-line matched user in the connection.

25. The system according to claim 21, wherein the on-line messenger further comprises:
a AV data compressing/decompressing subroutine for compressing or decompressing and converting between audio and video(AV) data and network transferable data and building a connection to a matched on-line member; and
a AV data processing subroutine for being triggered to receive AV data from a microphone and video camera, transmit AV data of the user to the AV data compressing/decompressing subroutine, receive AV data of the on-line matched user from the compressing/decompressing subroutine and play it via a speaker and a monitor in the client terminal.

26. The system according to claim 19, wherein the system further comprises:
a login subroutine for providing the user to register, log in and log off the system;
an on-line user database for recording users who login in the system and are on line;
an on-line search unit for retrieving an on-line matched user from the on-line user database and providing on-line contact to the on-line matched user, wherein the on-line search unit comprises:
an on-line searcher for connecting to the on-line user database to retrieve the on-line matched user; and
a contact agent for retrieving an Internet Protocol (IP) address of the on-line matched user from the user profile database;
and
an on-line contact client unit for being installed in the client terminal for building on-line communication to the on-line matched user according the IP address;
wherein the user inputs the on-line search conditions via the first UI; the on-line searcher retrieves an on-line search result; and the on-line contact client unit is triggered to build the on-line communication to the on-line matched user of the on-line search result.

27. The system according to claim 26, wherein the system further comprises a search condition database for storing the on-line search conditions.

28. The system according to claim 26, wherein the on-line contact client comprises an talk agent for building a connection to transmit sound data received from a microphone of the client terminal and to receive and play talks of the on-line matched user.

29. The system according to claim 26, wherein the on-line contact client comprises an AV agent for building a connection to transmit audio and video (AV) data received from a microphone and video camera of the client terminal and to receive and play AV data of the on-line matched user by a speaker and monitor in the client terminal.

30. The system according to claim 19, wherein the system comprises:
a web email agent for receiving and sending emails by the user;
a TSR (terminate-and-stay-resident) installed in the client terminal to connect a scheduler of the client terminal; and
an email analyzing unit for monitoring the web email agent and checking a new email received from the web email agent; wherein the email analyzing unit comprises:
an email analyzer for monitoring the web email agent and checking the new email;
an account manager for managing states of accounts of the user;
a user account database for storing data and states of accounts; and
an appointment arranging subroutine for connecting to the TSR to arrange appointments in the scheduler;
wherein if the new email analyzed by the email analyzer is concerned with accounts of the user, the account manager is triggered to update the states of the accounts in the user account database and if the new email is concerned with an appointment request, the appointment arranging subroutine is triggered to arrange the appointment request into the scheduler via the TSR.

31. The system according claim 30, wherein the system checks the content of the new email by a method of the following steps:
a. proceeding step c if the new email arrives, else proceeding step b;
b. waiting a predetermined time and then proceeding the step a;
c. proceeding step d if a sender of the new email is a member of the relationship-searching hosts; or proceeding step g if the new email is sent from the relationship-searching hosts; else ending the method;
d. storing the new email;
e. proceeding step f if the user is to reply the new email, else ending the method;
f. replying the new email and storing a replied email and ending the method;
g. proceeding step h if the email is a newly user profile report; or proceeding step i if the email is concerned with accounts of the user, else ending the method;
h. storing new user profiles of the email in the found profile database and ending the method; and
i. checking the content of the email and updating the user account database.

32. The system according to claim 31, wherein between the step d and e further comprises:
d1. proceeding step d2 if the new email is an appointment request, else proceeding step e;
d2 . proceeding step d3 if the user wants to make an appointment with the sender, else proceeding step d7;
d3 . proceeding step d6 if the user accepts the appointment, else proceeding step d4;
d4. replying another appointment with a suggested schedule;
d5. storing a corresponding reply of the user and ending the method;
d6. replying a confirmed email, adding this appointment into a scheduler, and proceeding the step d5;
d7. proceeding step d8 if the user is to reply the request email, else proceeding step d9;
d8. replying a refuse email and proceeding the step d5; and
d9. suspending the request mail.

33. The system according to claim 19, the client terminal is a computer.

34. The system according to claim 19, the client terminal is a personal digital assistant (PDA).

35. The system according to claim 19, the client terminal is a cellular phone or lined telephone.

36. The system according to claim 1, wherein the relationship-searching hosts at least comprise a relationship-searching website.

37. The system according to claim 1, wherein the relationship-searching hosts at least comprise a personal profile database.

38. The system according to claim 1, wherein the first UI is a graphical user interface.

39. The system according to claim 1, wherein the system further comprises a function of adding new relationship-searching hosts for providing the user to add an address of a new relationship-searching host to notify the system management department or representative.

40. A system for registering in multiple relationship-searching hosts, wherein the relationship-searching hosts allow users to register via a communication link, the system comprising:
a user interface (UI) for a user to control the system;
a server data format database for storing data format of registration of the relationship-searching hosts;
a profile poster for transmitting a new or modified user profile, which is inputted via the UI for registering in the relationship-searching hosts, to the relationship-searching hosts with each of the transmitting new or modified profile's data format retrieved from the server data format database; and
a user profile database for storing the new or modified profile;
wherein, after the user inputs the user profile via the UI, the profile poster updates the user profile database and transmits the user profile to the relationship-searching hosts; then the relationship-searching hosts receive the user profile.

41. The system according to claim 40, wherein the profile poster is further for deleting the user profile from the relationship-searching hosts.

42. The system according to claim 40, wherein the system is installed in a client terminal to provide the user to connect the relationship-searching hosts via the communication link.

43. The system according to claim 42, the client terminal is a computer.

44. The system according to claim 42, the client terminal is a personal digital assistant (PDA).

45. The system according to claim 42, the client terminal is a cellular phone or lined telephone.

46. The system according to claim 40, wherein the system is installed in a server and the user uses a client terminal to connect to the server via the communication link.

47. The system according to claim 46, the client terminal is a computer.

48. The system according to claim 46, the client terminal is a personal digital assistant (PDA).

49. The system according to claim 46, the client terminal is a cellular phone or lined telephone.

50. The system according to claim 40, wherein the relationship-searching hosts at least comprise a relationship-searching website.

51. The system according to claim 40, wherein the system further comprises a function of adding new relationship-searching hosts for providing the user to add an address of a new relationship-searching host to notify the system department or representative.

52. The system according to claim 40, wherein the relationship-searching hosts at least comprise a personal profile database.

53. A method for registering in multiple relationship-searching hosts by a computer to access a user profile, the method comprising the steps of:
a. inputting or modifying the user profile in the computer;
b. storing or updating the user profile in a user profile database in the computer; and
c. posting the user profile to the relationship-searching hosts with each of the hosts' data format retrieved from a server data format database in the computer.

54. The method according to claim 53, wherein the method further comprises the following step:
d. storing or updating the user profile by the relationship-searching hosts;
wherein some of the relationship-searching hosts respectively comprise a direct channel for receiving the user profile and accessing a personal profile database in the corresponding relationship-searching host.

55. The method according to claim 53, wherein the method is further for deleting the user profile from the relationship-searching hosts.

56. The method according to claim 53, wherein the computer is a client computer.

57. The method according to claim 53, wherein the computer is a server.

58. A method for searching in multiple relationship-searching hosts via a computer, wherein the computer comprises a user interface (UI) to access search conditions, the method comprising the steps of:
a. inputting the search conditions on the UI;
b. transmitting the search conditions to the hosts with each of the hosts'data format retrieved from a server data format database in the computer;
c. retrieving search results according to the search conditions and transmitting the search results to the computer by the hosts; and
d. storing the search results in a found profile database of the computer.

59. The method according to claim 58, wherein the method further comprises the following steps:
e. inputting refining criteria on the UI;
f. refining the search results and retrieving refining results; and
g. storing the refining results to the found profile database and displaying the refining results on the UI.

60. The method according to claim 58, wherein the computer is a client computer.

61. The method according to claim 58, wherein the computer is a server.

62. A system of allowing multi-users to connect to search relationship, wherein a user uses a client terminal to connect the system, the system comprising:
a login subroutine for providing the user to register, log in and log off the system;
a user profile database for storing data of all registering users and recording on-line users who login in the system presently;
an on-line searcher allowing the user to input on-line search conditions for retrieving an on-line matched user from the user profile database; and
an on-line messenger for building on-line communication to the on-line matched user.

63. The system according to claim 62, wherein the system further comprises a search condition database for storing the on-line search conditions.

64. The system according to claim 62, wherein the on-line searcher is installed in the client terminal.

65. The system according to claim 62, wherein the system further comprises a search poster for retrieving search results from the user profile database.

66. The system according to claim 65, wherein the search poster is installed in the client terminal.

67. The system according to claim 62, wherein the system further comprises an email agent for providing the user to communicate with a user of the search results or the on-line matched user.

68. The system according to claim 62, wherein the on-line messenger further comprises:
a sound data compressing/decompressing subroutine for compressing or decompressing and converting between sound data and network transferable data and building a connection to the on-line matched user; and
a talk subroutine for being triggered to receive sound data from a microphone, transmit sound data of the user to the sound data compressing/decompressing subroutine, receive sound data of the on-line matched user from the compressing/decompressing subroutine and play it via a speaker in the client terminal.

69. The system according to claim 62, wherein the on-line messenger further comprises a chat-and-short-message subroutine for building a connection to the on-line matched user, transmitting input of the user and receiving input of the on-line matched user in the connection.

70. The system according to claim 62, wherein the on-line messenger further comprises:
an AV data compressing/decompressing subroutine for compressing or decompressing and converting between audio and video (AV) data and network transferable data and building a connection to the on-line matched user; and
an AV data processing subroutine for being triggered to receive AV data from a microphone and a video camera, transmit AV sound data of the user to the AV data compressing/decompressing subroutine, receive AV data of the on-line matched user from the compressing/decompressing subroutine and play it via a speaker and a monitor in the client terminal.

71. The system according to claim 62, the client terminal is a computer.

72. The system according to claim 62, the client terminal is a personal digital assistant (PDA).

73. The system according to claim 62, the client terminal is a cellular phone or lined telephone.
